(19) United States
(12) Patent Application Publication
(10) Pub. No.: US 2010/0060680 A1
(43) Pub. Date: Mar. 11, 2010

(54) METHOD OF PRINTING LINE BY USING INKJET APPARATUS

(75) Inventors: Jae-Chan PARK, Suwon-si (KR); Jae-Woo Joung, Suwon-si (KR); Ro-Woon Lee, Seoul (KR); Yong-Sik Kim, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/551,195

(22) Filed: Aug. 31, 2009

(30) Foreign Application Priority Data
Sep. 10, 2008 (KR) 10-2008-0089092

(51) Int. Cl. B41J 29/38

(52) U.S. Cl. 347/9

(57) ABSTRACT

Disclosed is a method of printing a circuit line on the board by using an inkjet apparatus. The line printing method of an embodiment can include forming an original bitmap image including information related to a circuit line to be printed on the board; firstly printing the circuit line according to the original bitmap image on the board by using the inkjet apparatus; forming a first printed image by photographing the circuit line firstly printed on the board; forming a complementary bitmap image including complementary printing information corresponding to a defectively printed portion based on the first printed image; and secondly printing a pertinent portion according to the complementary bitmap image on the board by using the inkjet apparatus.

### CROSS-REFERENCE TO RELATED APPLICATIONS

This application claims the benefit of Korean Patent Application No. 10-2008-0089092 filed with the Korean Intellectual Property Office on Sep. 10, 2008, the disclosure of which is incorporated herein by reference in its entirety.

### BACKGROUND

1. Technical Field

The present invention relates to a circuit line forming method, more specifically to a method of printing a circuit line by using an inkjet apparatus.

2. Description of the Related Art

The inkjet printing technology has been mainly used for office automation (OA) in the office environment, and for marking the packing-material or printing on apparel for industrial purposes. However, as the applicability of the printing technology is expanded with the development of functional ink including nanoparticles of a metal such as silver or nickel, the circuit pattern of a printed circuit board can be formed at present by using the functional ink including metal nanoparticles.

There has recently been the growing development of inkjet technologies. In the electronics industry, studies are widely conducted to apply the inkjet to the process of manufacturing printed circuit boards (PCB) or color filters of liquid crystal displays. Unlike the office applications of the inkjet, it is necessary that all of the 128 or 256 nozzles formed in the inkjet head are properly operated in order to use the inkjet for industrial purposes.

With the development of inkjet technologies, the size of the nozzle of the inkjet printer head is decreased to below 10 μm. This causes some problems. For example, while the printing is performed with the use of the inkjet print head, the size of a discharged ink droplet becomes significantly smaller or the ink easily becomes dry depending on the environment conditions such as ambient temperature, humidity, and dust so that a viscous membrane is formed on the nozzle. This may cause the nozzle to be clogged. These problems bring about the disconnection of circuit lines to be printed on the board, and as a result, the PCB becomes defective.

Accordingly, there has been the demand for solution of the above problems caused by the currently developed inkjet technologies.

### SUMMARY

Accordingly, the present invention provides a technology, which is related to the improvement of printing quality of an inkjet system being used for industrial and personal printers, to mass-produce the high quality printed materials (e.g. printed circuit boards) by secondly performing the complementary printing of defective portions after performing the first printing.

An aspect of present invention features a method of printing a circuit line on a board by using an inkjet apparatus including generating an original bitmap image including information related to a circuit line to be printed on the board; performing an initial printing of the circuit line on the board by using the inkjet apparatus, the circuit line corresponding to the original bitmap image; generating an initial print image by photographing the circuit line initially printed on the board; generating a complementary bitmap image including complementary printing information based on the initial print image, the complementary printing information corresponding to a portion printed defectively; and performing a secondary printing of a pertinent portion on the board by using the inkjet apparatus, the pertinent portion corresponding to the complementary bitmap image.

Here, the inkjet apparatus can employ a piezoelectric inkjet print head including a plurality of pressure chambers configured to be filled with ink to be discharged, a piezoelectric actuator configured to provide driving force for discharging the ink to each of the plurality of pressure chambers, a manifold holding the ink to be provided to the plurality of pressure chambers, a plurality of restrictors for providing the ink from the manifold to each of the plurality of pressure chambers, and a plurality of nozzles for discharging the ink from the plurality of pressure chambers; and the plurality of nozzles are arranged in array along a longitudinal direction of the inkjet print head.

The original and complementary bitmap images can have a resolution (i.e. dots per inch (DPI)) in which one pixel corresponds to a size printed by one ink droplet being discharged from a nozzle included in the inkjet apparatus.

The original and complementary bitmap images can be generated by bitmap-imaging an entire area of a printing table in which the board is to be loaded and then inputting information related to the circuit line to be printed on the board according to a coordinate corresponding to an actual position loaded on the printing table.

The generating of the complementary bitmap image can include bitmap-imaging the initial print image; comparing the bitmap-imaged initial print image with the original bitmap image; and generating the complementary bitmap image based on a result of the comparing, the complementary bitmap image corresponding to the portion printed defectively in the initial printing.

The method can further include, prior to the performing of the secondary printing, replacing or cleaning a nozzle based on the complementary printing information, the nozzle having caused the defective printing in the initial printing by the inkjet apparatus.

In addition, the secondary printing can be performed by normally operated nozzles excluding a nozzle based on the complementary printing information, the excluded nozzle having caused the defective printing in the initial printing by the inkjet apparatus.

### BRIEF DESCRIPTION OF THE DRAWINGS

FIG. 1 is an exploded perspective view showing a piezoelectric inkjet print head that is applicable to a line printing method in accordance with an embodiment;

FIG. 2 is a vertical cross-sectional view of the piezoelectric inkjet print head shown in FIG. 1;

FIG. 3 and FIG. 4 show how the piezoelectric inkjet print head in FIG. 2 is operated;

FIG. 5 is a flow chart showing a line printing method in accordance with an embodiment;

FIG. 6A shows a bitmap image including information related to a circuit line to be printed on the board;

FIG. 6B shows a location of the board that is loaded onto a printing table;

FIG. 6C shows an original bitmap image in FIG. 6A to which the circuit line information is inputted according to a coordinate corresponding to the loaded location of the board in FIG. 6B;

FIG. 6D shows an initial print image having a portion printed defectively in an initial printing; and

FIG. 6E shows a complementary bitmap image generated based on the initial print image of FIG. 6D.

### DETAIL DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to another element directly but also as possibly having yet another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

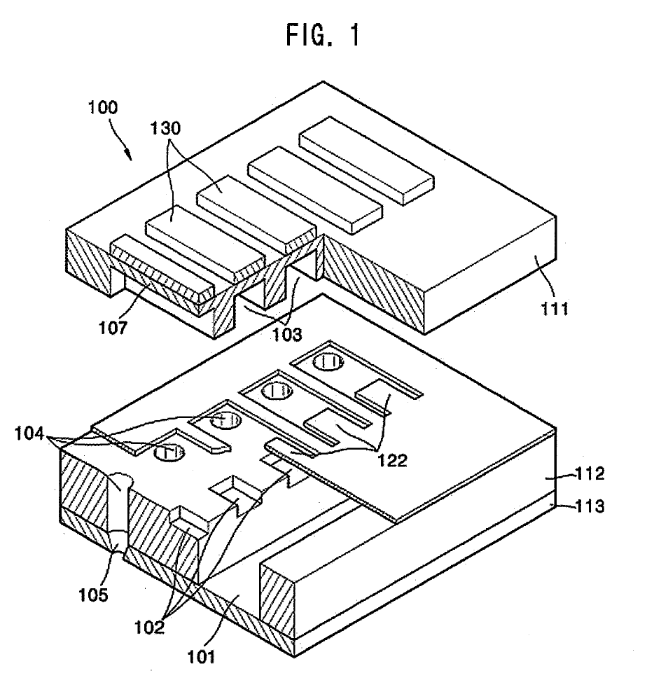

The structure and operating principle of an inkjet apparatus that is applicable to a line printing method according to an embodiment will be firstly described with reference to the accompanying FIG. 1 through FIG. 4, prior to describing the line printing method according to an embodiment.

Typically, there are two types of inkjet apparatuses, based on the method of discharging ink. One type employs a thermal inkjet print head, which creates a bubble in the ink by using a heat source and discharges the ink by using the expansion of the bubble. The other type employs an electrical inkjet print head, which discharges the ink by using a electrostatic attraction or repulsion or the transformation of a piezoelectric element applied with voltage.

Of cause, any one of the two inkjet print heads can be used for the line printing method in accordance with an embodiment of the present invention, and the piezoelectric inkjet print head shown in FIGS. 1 through 4 is a mere example.

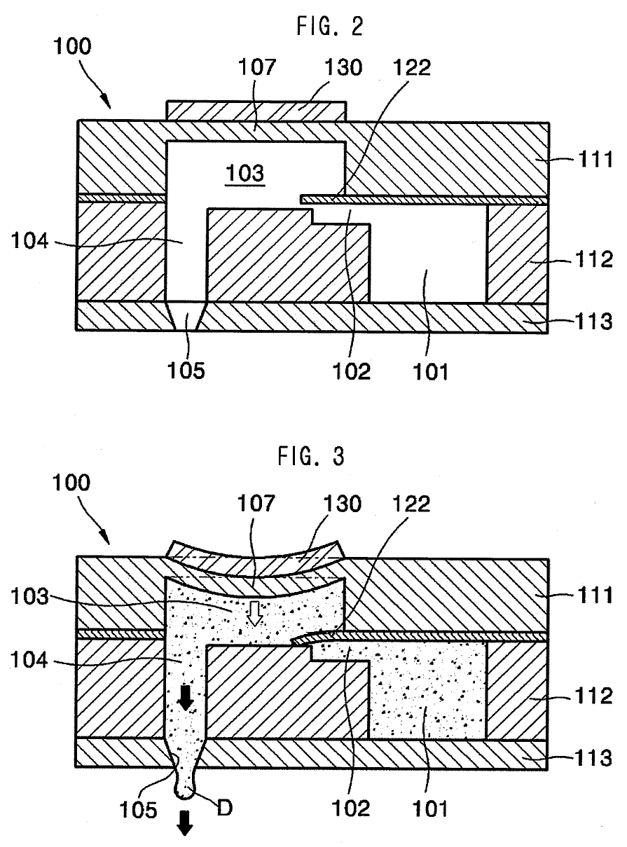

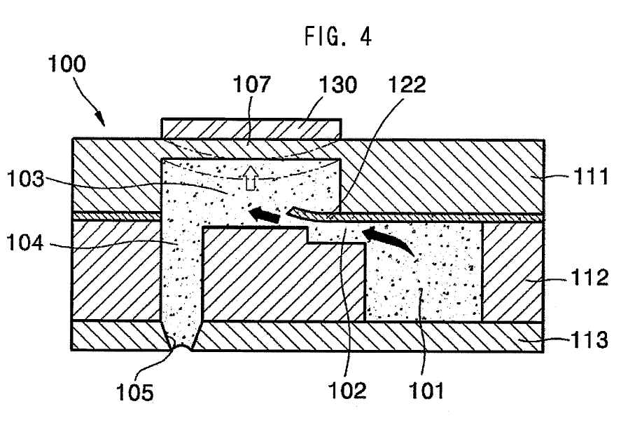

FIG. 1 is an exploded perspective view showing a piezoelectric inkjet print head that is applicable to a line printing method in accordance with an embodiment, and FIG. 2 is a vertical cross-sectional view of the piezoelectric inkjet print head shown in FIG. 1. FIG. 3 and FIG. 4 show how the piezoelectric inkjet print head in FIG. 2 is operated.

As shown in FIG. 1 and FIG. 2, a piezoelectric inkjet print head 100 can include an ink path having a plurality of pressure chambers 103, a piezoelectric actuator 130 providing driving force for discharging the ink to each of the plurality of pressure chambers 103, and a plurality of one-way shutters 122 installed in the ink path to prevent the ink from inversely flowing.

The ink path can include the plurality of pressure chambers 103, being filled with the ink to be discharged and generating a change of pressure for discharging the ink, a manifold 101, holding the ink to be provided to the plurality of pressure chambers 103, a plurality of restrictors 102, providing the ink from the manifold 101 to each of the plurality of pressure chambers 103, and a plurality of nozzles 105, discharging the ink from the plurality of pressure chambers 103.

Here, the plurality of nozzles 105, as shown in FIG. 1, can be arranged in the form of an array in the longitudinal direction of the inkjet print head 100. Although FIG. 1 shows that the plurality of nozzles 105 are arranged in one line in the longitudinal direction of the inkjet print head 100, the plurality of nozzles 105 can be also arranged in two or more lines in the longitudinal direction of the inkjet print head 100.

Moreover, although FIG. 1 only shows 5 nozzles 105 for the convenience of illustration, there is no restriction on the number of the nozzles 105.

A damper 105 can be placed between the pressure chambers 103 and the nozzles 105 to focus the energy generated by the piezoelectric actuator 130 toward the nozzle 105 and to buffer a rapid change in pressure.

The elements of the ink path can be formed on a plurality of stacked path plates 111, 112, and 113. The plurality of path plates 111, 112, and 113 can include a first path plate 111, a second path plate 112, and a third plate 113.

More specifically, the plurality of pressure chambers 103 having predetermined depths can be formed on a lower side of the first path plate 111. The plurality of pressure chambers 103 can be arranged side by side, and each of the plurality of pressure chambers 103 can have a rectangular form in the flowing direction of the ink. An upper wall formed by the pressure chambers 103 of the first plate 111 can function as a diaphragm 107 being transformed by the driving of the piezoelectric actuator 130.

The manifold 101 can be formed on the second path plate 112. As shown in FIG. 1, the manifold 101 can be vertically penetrating the second path plate 112 or have a predetermined depth from an upper side of the second path plate 112. The plurality of restrictors 102 can be formed on the second path plate 112 to connect each end part of the manifold 101 and the plurality of pressure chambers 103.

As shown in FIG. 1, the restrictors 102 can have predetermined depths from an upper side of the second path plate 112. The damper 104 connecting the pressure chambers 103 and the nozzles 105 can be vertically penetrating the second path plate 112, to correspond to each of the other end parts of the pressure chambers 103.

The nozzles 105 can be penetrating the third path plate 113, to correspond to the damper 104. The nozzles 105 can have a taper shape, the cross section of which becomes decreased toward its outlet.

The three path plates 111, 112, and 113 can be silicon substrates. In this case, the ink path can be variously formed by macro-machining a surface of the silicon substrate through a semiconductor process. However, the path plate is not limited to the silicon substrate. The three path plates 111, 112, and 113 can be different substrates from one another as long as they can be easily machined.

Although FIG. 1 shows that the elements of the ink path are arranged in the three different path plates 111, 112, and 113, this is merely an example, and the inkjet print head 100 in accordance with an embodiment of the present invention can include various structures of ink path(s). The ink path(s) can be formed on the path plate(s), the number of which is greater or smaller as compared with the three path plates 111, 112, and 113.

The piezoelectric actuator 130 can be formed in an upper side of the first path plate 111, on which the pressure chambers 103 are formed, to provide the driving force for discharging the ink to the pressure chambers 103. Although not illustrated in the drawing, the piezoelectric actuator 130 can have a structure in which a lower electrode, functioning as a common electrode, a piezoelectric film (e.g. a PZT film), being transformed according to whether the power is supplied, and an upper electrode, functioning as a driving electrode, are successively stacked on the first path plate 111.

The one-way shutter 122 can be mounted in each outlet of the restrictors 102. Here, the one-way shutter 122 can prevent the ink from inversely flowing by allowing the restrictors 102 to open when the ink is supplied from the restrictors 102 to the pressure chambers 103 and to close when the ink is discharged from the pressure chambers 103 through the nozzles 105. The one-way shutter 122, however, is merely an additional element that is functionally added to more efficiently prevent the ink from inversely flowing when the inkjet print head is operated. Accordingly, the one-way shutter 122 can be omitted.

Hereinafter, the operating principle of the inkjet print head 100 shown in FIG. 1 and FIG. 2 will be briefly described with reference to FIG. 3 and FIG. 4.

As shown in FIG. 3, if the piezoelectric actuator 130 is operated to discharge the ink, the diaphragm 107 placed at a lower side of the piezoelectric actuator 130 can be transformed, thereby reducing the volume of the pressure chambers 103. Accordingly, the pressure in the pressure chambers 103 can be increased. This can discharge the ink in the pressure chambers 103 to the outside through the damper 104 and the nozzles 105. At this time, the increased pressure in the pressure chambers 103 may cause the one-way shutter 122 to be curved toward the lower side. This may close the outlets of the restrictors. Thus, it can be possible to completely prevent the ink from flowing from the pressure chambers 103 to the restrictors 102.

Similarly, if the ink is discharged and then the diaphragm 107 is recovered to its original state as shown in FIG. 4, the volume of the pressure chambers 103 can be increased. Accordingly, the pressure in the pressure chambers 103 can be changed. This may cause the one-way shutter 122 to be curved toward the upper side, thereby opening the outlets of the restrictors 102. Thus, the ink stored in the manifold 101 can flow into the pressure chamber 103 through the restrictors 102.

As described above, in the piezoelectric inkjet print head 100 in FIG. 1 and FIG. 2, the ink can be discharged by the change in the pressure of the pressure chambers 103 according to whether the piezoelectric actuator 130 is operated.

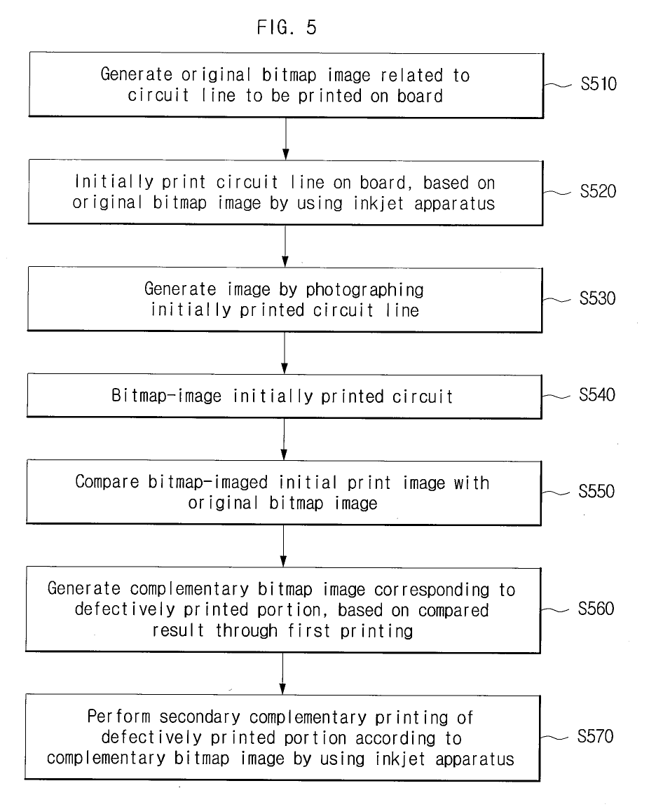

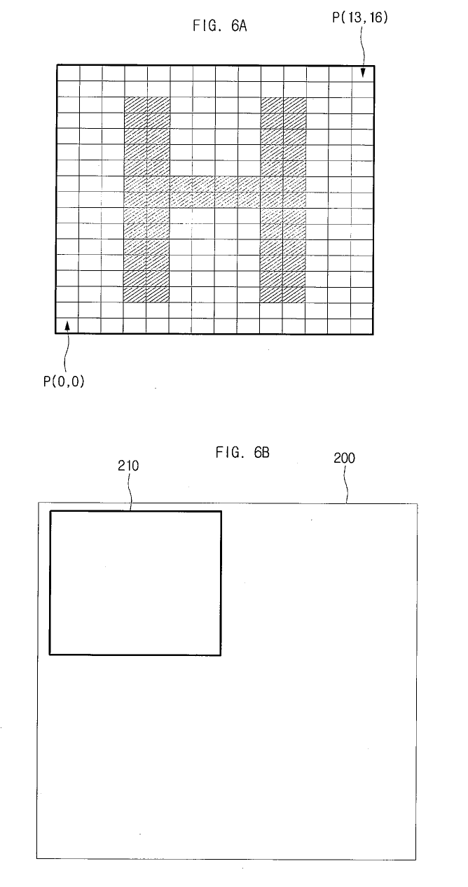

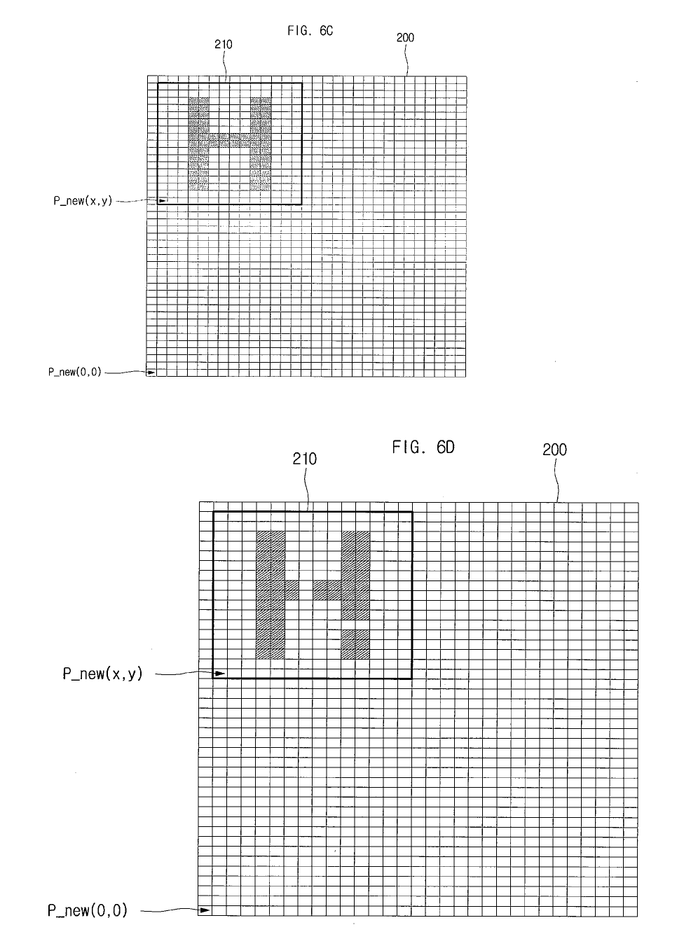

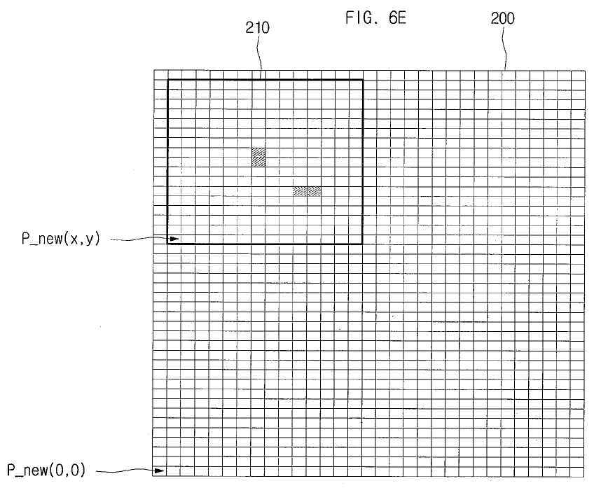

Hitherto, an inkjet apparatus that can be used in accordance with an embodiment has been described. An line printing method using the inkjet apparatus in accordance with an embodiment will be described below in detail with reference to FIG. 5 and FIG. 6A through FIG. 6E.

FIG. 5 is a flow chart showing a line printing method in accordance with an embodiment.

As shown in FIG. 5, an operation represented by S510 can generate an original bitmap image related to a circuit line to be printed on a board.

Here, in the case of a printed circuit board, the original bitmap image refers to the bitmap image having coordinate information related to each circuit line (i.e. a conductive line such as a metal line) to be printed on the printed circuit board.

Described below is a process of generating the above original bitmap image.

It is assumed that the circuit line to be printed on the board is an “H-shaped” line. The H-shaped line can be firstly prepared as a bitmap file according to the position coordinate in which the line is to be printed as shown in FIG. 6A. In the case of the most simplified bitmap file, “binary 1” is given to pixels (i.e. the shadowed portions in FIG. 6A) corresponding to the coordinate in which the line is to be printed, and “binary 0” is given to pixels corresponding to the other coordinates (or vice versa).

However, since FIG. 6A shows the bitmap file formed based only on an object (i.e. a board 210) in which the circuit line is actually to be printed, it may be required to convert the bitmap file in FIG. 6A to the file in FIG. 6C based on a printing table 200 in order to apply it to the actual printing operation using the inkjet apparatus.

As shown in FIG. 6C, the original bitmap image can be formed by bitmap-imaging all portions of the printing table 200 in which the board 210 is to be loaded and then inputting information related to the circuit line to be printed on the board 210 according to the coordinate corresponding to the actual position (refer to FIG. 6B) loaded on the printing table 200. This is similar to a complementary bitmap image in FIG. 6E, which will be described later.

Accordingly, the old coordinates (i.e. the coordinates based on P(0,0) in FIG. 6E) can be converted to new coordinates (i.e. the coordinates based on P_new(x,y) in FIG. 6C) based on the printing table 200 (i.e. P_new(0.0)) in FIG. 6C.

At this time, one pixel of the original bitmap image in FIG. 6C can correspond to the same size as a size printed by one ink droplet being discharged from the nozzle of the inkjet apparatus. The same is applied to the complementary bitmap image in FIG. 6E to be described later. In this case, the original bitmap image being generated through the operation represented by S510 will have a resolution (i.e. dots per inch (DPI)), in which one pixel size corresponds to the size printed by one ink droplet being discharged from a nozzle of the inkjet apparatus. However, the resolution of the original bitmap image can be adjusted or changed in various ways according to the design specifications.

After generating the original bitmap image related to the circuit line to be printed on the board as descried above, an operation represented by S520 can actually print the circuit line on the board according to the original bitmap image by using the inkjet apparatus. In this specification, the operation of printing the line according to the original bitmap image is referred to as an initial printing operation for the convenience of being distinguished from a complementary printing operation to be described later.

For example, the initial printing operation can be performed by allowing the nozzles, which are mapped to coordinates (i.e. pixels) where the circuit line is to be printed, among a plurality of nozzles included in the inkjet print head to discharge ink droplets at pertinent coordinates and other nozzles to stop discharging the ink, according to the original bitmap image. At this time, the inkjet print head can be configured to move in X-axis and Y-axis directions. Accordingly, the line printing can be performed by allowing the inkjet print head to print a row in the X-axis direction and move in the Y-axis direction to print a next row according to a predetermined order.

Alternatively, the inkjet print head can be configured to perform the printing in any one direction in a typical inkjet system. For example, the inkjet print head can be configured to horizontally move in the X-axis direction to perform the line printing. The printing table can be also linked to the inkjet print head to move in the Y-axis direction according to the printing order. This can perform the line printing of the overall two-dimensional area of the object (i.e. the substrate).

On the other hand, defective printing in the line printing operation is an urgent and serious problem that should be solved for mass production. Typically, any printed circuit board having a defect caused by blockage, defect or malfunction of a nozzle has been labeled defective and discarded, resulting in lowered productivity of mass production and higher product price due to the increased cost and time for handling the defect and discard.

In other words, if defective printing is caused by the blockage of a nozzle while the printing is conventionally performed by using the inkjet apparatus, there is no method to complement the defective printing. Moreover, the typical line printing method has not been able to recognize the location of a defective pixel or partially complement the print image and re-print the image.

Accordingly, an embodiment of the present invention can fundamentally solve the problem of print defect through a secondary complementary printing method, which can greatly improve the productivity and product reliability and lower product cost. This can be more clearly understood through the below operations represented by S530 to S570.

An operation represented by S530 can acquire an image (hereinafter, referred to as an initial print image) generated by photographing the circuit line initially printed through the prior operations. There has been an operation of checking the print image by using a photographing apparatus to check whether there is defective printing. Accordingly, the detailed description related to the photographing method will be omitted.

This embodiment, however, can perform an automatic analyzing operation of the image instead of the conventional visual checking operation.

In particular, an operation represented by S540 can bitmap-image the initial print image acquired through the operation represented by S530. Then, an operation represented by S550 can compare the bitmap-imaged initial print image with the original bitmap image, thereby recognizing the location of defective printing performed in the initial printing operation.

FIG. 6D shows an example of the initial print image acquired through the operation represented by S530, which has been bitmap-imaged by the operation represented by S540. According to FIG. 6D, it can be recognized that there are defectively printed portions in the bitmap-imaged initial print image.

Accordingly, the precise coordinates corresponding to the portions (i.e. the shadowed portions in FIG. 6E), in which defective printing is performed, can be recognized by comparing the bitmap-imaged initial print image of FIG. 6D with the original bitmap image of FIG. 6C.

Thereafter, in this embodiment, an operation represented by S560 can generate a complementary bitmap image having complementary printing information (i.e. information related to coordinates requiring the complementary printing) corresponding to the defectively printed portions through the initial printing, based on the compared result.

The complementary bitmap image generated through the operation represented by S560 can be the same as that of FIG. 6E. An operation represented by S570 can make a secondary print of the defectively printed portions based on the complementary bitmap image on the board by using the inkjet apparatus. This can manufacture a high-quality printed circuit board by correcting its defective printing.

The secondary printing operation of S570 can be performed by any of the following two methods. In one method, if the complementary printing information (i.e. information related to coordinates requiring the complementary printing) included in the complementary bitmap image is analyzed, the nozzle (i.e. the malfunctioned nozzle) causing the defective printing in the initial printing operation can be recognized. This may be because all of the initial printing operation is recorded. Accordingly, if the records are inversely tracked, it can be possible to recognize nozzle information corresponding to coordinates in which the defective printing is performed.

In other words, the inkjet system can very precisely control a head position of a nozzle discharging the ink and the position of the printing table by using their coordinates. This can allow the pertinent nozzle to be placed at the position requiring the complementary printing, and the circuit line can be completely printed through the complementary printing.

The secondary printing can be performed by, for example, repairing the nozzle causing the defective printing through replacement or cleaning of the malfunctioned nozzle and then using the complementary bitmap image having the coordinates related the portions requiring the complementary printing.

In the other method, the secondary printing can be performed by using the normally operated nozzles excluding the defective nozzle causing the defective printing in the initial printing operation.

As described above, an embodiment of the present invention can manufacture a high-quality print material (e.g. a printed circuit board) that can be easily mass-produced, by performing the secondary printing of a portion causing defective printing after the initial printing according to a bitmap image re-generated through image processing.

Although some embodiments of the present invention have been described, anyone of ordinary skill in the art to which the invention pertains should be able to understand that a very large number of permutations are possible without departing the spirit and scope of the present invention and its equivalents, which shall only be defined by the claims appended below.

What is claimed is:

1. A method of printing a circuit line on a board by using an inkjet apparatus, the method comprising:
generating an original bitmap image including information related to a circuit line to be printed on the board;
performing an initial printing of the circuit line on the board by using the inkjet apparatus, the circuit line corresponding to the original bitmap image;
generating an initial print image by photographing the circuit line initially printed on the board;
generating a complementary bitmap image including complementary printing information based on the initial print image, the complementary printing information corresponding to a portion printed defectively; and
performing a secondary printing of a pertinent portion on the board by using the inkjet apparatus, the pertinent portion corresponding to the complementary bitmap image.

2. The method of claim 1, wherein:
the inkjet apparatus employs a piezoelectric inkjet print head comprising a plurality of pressure chambers configured to be filled with ink to be discharged, a piezoelectric actuator configured to provide driving force for discharging the ink to each of the plurality of pressure chambers, a manifold holding the ink to be provided to the plurality of pressure chambers, a plurality of restrictors for providing the ink from the manifold to each of the plurality of pressure chambers, and a plurality of nozzles for discharging the ink from the plurality of pressure chambers; and
the plurality of nozzles are arranged in array along a longitudinal direction of the inkjet print head.

3. The method of claim 1, wherein the original and complementary bitmap images have a resolution (i.e., dots per inch (DPI)) in which one pixel corresponds to a size printed by one ink droplet being discharged from a nozzle included in the inkjet apparatus.

4. The method of claim 1, wherein the original and complementary bitmap images are generated by bitmap-imaging an entire area of a printing table in which the board is to be loaded and then inputting information related to the circuit line to be printed on the board according to a coordinate corresponding to an actual position loaded on the printing table.

5. The method of claim 1, wherein the generating of the complementary bitmap image comprises:
bitmap-imaging the initial print image;
comparing the bitmap-imaged initial print image with the original bitmap image; and
generating the complementary bitmap image based on a result of the comparing, the complementary bitmap image corresponding to the portion printed defectively in the initial printing.

6. The method of claim 1, further comprising, prior to the performing of the secondary printing, replacing or cleaning a nozzle based on the complementary printing information, the nozzle having caused the defective printing in the initial printing by the inkjet apparatus.

7. The method of claim 1, wherein the secondary printing is performed by normally operated nozzles excluding a nozzle based on the complementary printing information, the excluded nozzle having caused the defective printing in the initial printing by the inkjet apparatus.
